(19) United States
(12) Patent Application Publication
(10) Pub. No.: US 2010/0281510 A1
(43) Pub. Date: Nov. 4, 2010

(54) Method for Broadcasting or Receiving Digital Video Services, Corresponding Devices

(76) Inventors: Guillaume Bichot, La Chapelle Chaussee (FR); Helmut Burklin, Rennes (FR)

Correspondence Address: Robert D. Shedd, Patent Operations;THOMSON Licensing LLC, P.O. Box 5312, Princeton, NJ, 08543-5312, US

(21) Appl. No.: 12/223,146

(22) PCT Filed: Jan. 16, 2007
(86) PCT No.: PCT/EP2007/050391

§ 371 Date: Jun. 16, 2010

(30) Foreign Application Priority Data
Jan. 24, 2006 (FR) 0650249

(51) Int. Cl. H04N 7/173

(52) U.S. Cl. 725/114; 725/131

(57) ABSTRACT

The invention concerns a method for broadcasting digital video services including a step of transmitting digital video broadcasting services in radio frames addresses to at least one terminal having a standby mode and a sleep mode. In order that the terminal may stay in standby mode to receive data the modified content of the radio frames, at least a part of the radio frames comprises information representative of a change in the content of the radio frames. The invention also concerns a reception method implemented in the terminal as well as the corresponding devices.

### SCOPE OF THE INVENTION

This invention relates to the Digital Video Broadcast field (or DVB). More precisely, the invention relates to the broadcasting of services to terminals on a radio medium, the terminals receiving the services intermittently.

### TECHNOLOGICAL BACKGROUND

The DVB is in particular defined in the ETSI EN 301 192 (entitled ‘Digital Video Broadcasting (DVB); DVB specification for data broadcasting’) and TR 101 190 (entitled ‘Digital Video Broadcasting (DVB); Implementation guidelines for DVB terrestrial services; Transmission aspects’) standards. The DVB-H is in particular specified in the ETSI EN 302 304 (entitled ‘Digital Video Broadcasting (DVB); Transmission System for Handheld Terminals (DVB-H)’) and TR 102 377 (entitled ‘Digital Video Broadcasting (DVB); DVB-H Implementation Guidelines’) standards.

According to the prior art, a DVB-H television service (for example of the live television type or of the ‘Video On Demand’ (VOD) type can be broadcast or downloaded. A DVB-H IPE module receives the multicast streams from an IP network. According to their configuration, the module transmits them by grouping the streams belonging to the same service and encapsulates them in a frame with time slicing by adding to them Forward Error Correction (or FEC) information and signalling information according to the DVB-H standard. When a terminal receives a service, it can only receive this service by placing its reception means in sleep mode during the transmission of the other services. This technique nevertheless has the disadvantage of not making it possible for the terminal to have immediate access to other services following a configuration change indicated in a burst not corresponding to the received service.

### SUMMARY OF THE INVENTION

The purpose of the invention is to overcome the disadvantages of the prior art.

More particularly, the purpose of the invention is to allow an optimization of the access to digital television broadcasting services by a terminal while allowing a power saving of the terminal.

For this purpose, the invention proposes a method for broadcasting digital video services comprising a step for transmitting digital video broadcasting services in bursts to at least a terminal having a standby mode and a sleep mode, characterized in that at least one part of the bursts comprises information representative of a change in the content of the bursts, so that the terminal can stay in standby mode to receive data relating to the content of the bursts having changed.

So, when the terminal is listening (standby mode) to bursts associated with a channel (called, for example, current channel), and is in the sleep mode when bursts not associated with the current channel are transmitted, the terminal can be in the standby mode during the transmission of data relating to the content of at least one burst not associated with the current channel to receive this data.

Advantageously, the method comprises a step for inserting multi-protocol encapsulation frames called MPE frames in the bursts, at least one part of the MPE frames comprising information representative of a change in the content of the bursts.

According to a preferred characteristic, each of the MPE frames comprises information representative of a change in the content of the bursts.

Preferentially, the method comprises a step for inserting the information in at least one part of the MPE frames by a module generating the MPE frames.

According to particular characteristics, the information is representative of a system table change and/or an announcement channel change.

Advantageously, the method comprises an information state change step during a change in the content of the bursts.

According to another characteristic, the method comprises a step for placing the information in a predefined state, the predefined state being representative of a change in the content of the bursts.

The invention also relates to a method for receiving bursts, each of the bursts comprising at least one digital video broadcasting service, the method being remarkable in that it comprises the steps for:

receiving at least a burst by a terminal in standby mode;

detecting in a received burst information representative of a change in the content of broadcast bursts.

Preferentially, the method for receiving comprises a step for maintaining in standby mode when the terminal has detected information representative of a change as long as the terminal has not received the data corresponding to the content of the broadcast bursts, having changed.

Advantageously, the information is representative of a system table change and/or of a change of an announcement channel.

Advantageously, the reception method comprises a step for detecting a change in the state of the information, a change in the state being representative of a change in the content of the bursts.

According to another characteristic, the reception method comprises a step for detecting a predefined state of the information, the predefined state being representative of a change in the content of the bursts.

Moreover, the invention relates to a device for broadcasting digital video services comprising means for transmitting digital video broadcasting services in bursts to at least one terminal having a standby mode and a sleep mode, at least one part of the bursts comprises information representative of a change in the content of the bursts, so that the terminal can stay in standby mode to receive data relating to the content of the bursts having changed.

In addition, the invention relates to a device for receiving bursts, each of the bursts comprising at least one digital video broadcasting service, the device comprising:

means for receiving at least one burst by a terminal in standby mode;

means for detecting in a received burst, information representative of a change in the content of broadcast bursts.

### LIST OF FIGURES

The invention will be better understood, and other specific features and advantages will emerge from reading the following description, the description making reference to the annexed drawings wherein:

FIG. 1 diagrammatically illustrates a network infrastructure used to broadcast a DVB-H video service to a terminal, according to a particular embodiment of the invention,

FIG. 2 presents a structure of a data frame transmitted to the terminal of the infrastructure of FIG. 1,

FIG. 3 illustrates the time slicing of the services transmitted to the terminal of the infrastructure of FIG. 1,

FIG. 4 describes a burst transmitted to the terminal of the infrastructure of FIG. 1;

FIGS. 5 and 6 illustrate the structure respectively of a terminal and of an access point of the network of FIG. 1;

FIG. 7 presents an algorithm implemented in the terminal of FIG. 5; and

FIG. 8 describes an algorithm implemented in the access point of FIG. 6.

### DETAILED DESCRIPTION OF THE INVENTION

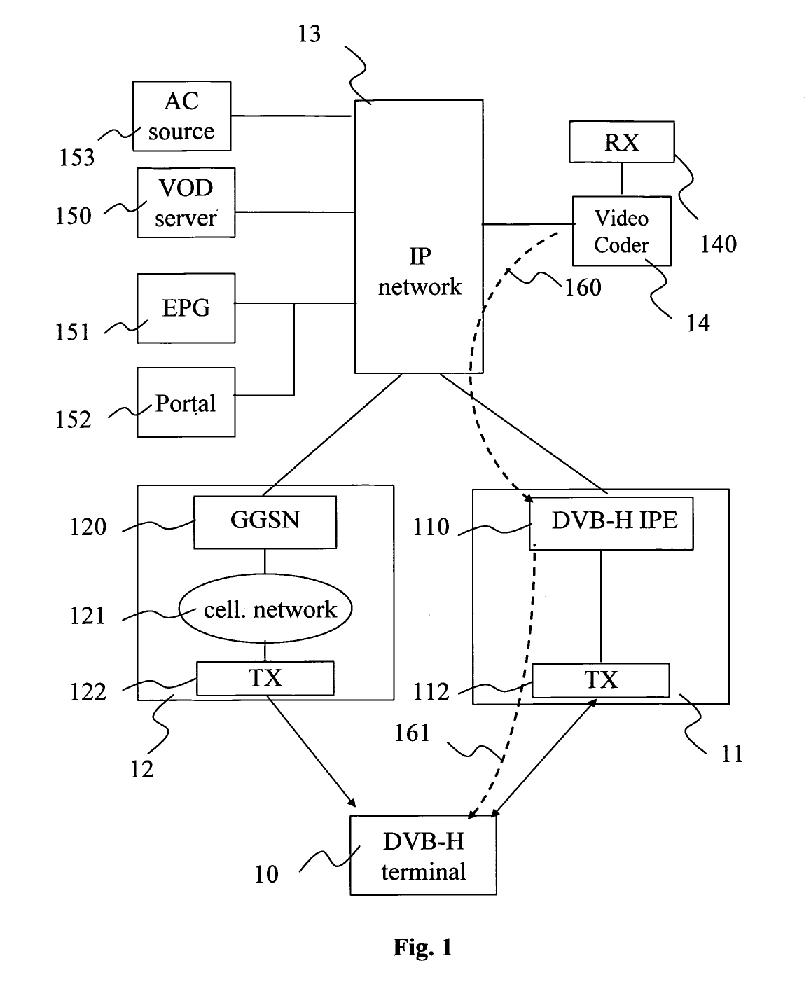

FIG. 1 diagrammatically illustrates a DVB-H network infrastructure used for the transmission of a DVB-H video service to a terminal 10 according to the H264 standard in QCIF (Quarter of ‘Common Intermediate Format’ corresponding to a 176×144 resolution). The infrastructure comprises in particular:

a IP network backbone 13,

a video coder 14 receiving data from a receiver 140 and codes (or transcodes) life channels,

servers respectively of VOD 150, EPG 151, a portal 152 and an announcement source 153,

a cellular network 12,

a DVB-H network 11, and

the terminal 10.

The servers 14 and 150 to 153 transmit DVB-H services to the terminal 10 via the IP 13 network and the DVB-H network 11. The average rate of the entire service is equal to about 250 kbits/s. The service gathers several IP (Internet Protocol) streams: one for video, one for audio and, possibly, other services (for example, session description (according to a SDP protocol)).

The DVB-H network 11 comprises in particular:

a module 110 for IP encapsulation (or IPE) of the DVB-H type; and

a transmitter 112.

The module 110 and transmitter 112 are preferentially in two separate devices. According to one variant, they are grouped in the same device.

The DVB-H IPE module 110 receives the multicast streams 160 from the IP 13 network according to a protocol of the RTP (‘Real Time Protocol’) type on UDP/IP (‘User Datagram Protocol on IP’). According to their configuration, module 110 transmits them to in particular the transmitter 112 by grouping the streams belonging to the same service and by encapsulating them in a frame 161 with time slicing by adding to them forward error correction (or FEC) information and signalling information according to the DVB-H standard, as well as a flag indicating changes in the services broadcast according to the invention. The transmission bitrate is generally high and can reach, for example, 15 Mbits/s. The MPEG-TS stream 161 is transmitted to the transmitter 112 via the backbone 11. The transmitter 112 then transmits along a DVB-H radio channel the MPEG-TS stream to the terminal 10 (and possibly other terminals implementing the invention or not). The terminal 10 then analyzes the DVB-H signalling information present in the stream 16, associates an IP address with a MPREG-TS address and can then read all the IP packets associated with this address and reconstructs the various streams 160 transmitted originally. As detailed further ahead, the terminal 10 detects possible changes in the broadcast services by analyzing the flags inserted in the received frame 161.

The cellular network 12 is of the 3G (that is to say third generation) type and comprises in particular:

a gateway 120 of the GGSN cellular network;

a backbone 121; and

a transmitter 122 (for example a base station).

The terminal 10 can exchange control data with the transmitter 122 enabling interactivity with the service supplier, video type data transiting via the DVB-H transmitter 112.

According to an embodiment variant not illustrated, the module 110 is linked to several transmitters similar to the transmitter 112 and transmits to them the same MPEG-TS stream 161.

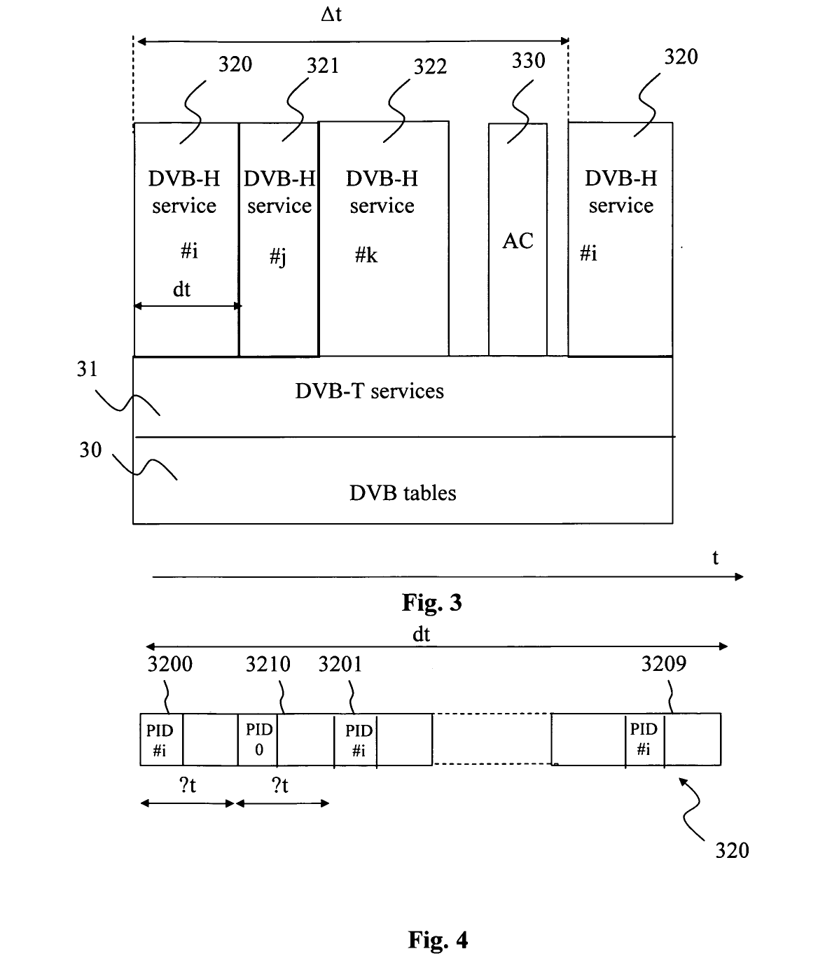

FIG. 3 presents the time slicing (according to a macroscopic view) of the services transmitted to the terminal 10 by the transmitter 112.

Some information is broadcast in an almost continuous manner by the transmitter 112 on a radio channel, in particular:

DVB-T (or terrestrial DVB) services 31; and

signalling information including DVB service tables 30.

The DVB service tables 30 (or system tables) are described in the DVB standards and comprise in particular:

a PAT (or ‘Program Access Table ’) table used to have access to the other tables used,

an INT table which gives the correspondence between an internet address and a transport stream.

Other information is broadcast intermittently in the form of burst by the transmitter 112, in particular:

frames 320, 321 and 322 corresponding to distinct DVB-H services i, j and k; and possibly,

signalling frames 330 corresponding, for example, to announcement channels.

The frames 330 are used to transmit to the terminal 10, when it listens to these frames, information specific to one or more services or information of a general nature (for example, backup services, new services, etc.).

In the established mode, the terminal 10 just listens to the service or services chosen by the user and its burst reception means (in particular a receiving module 54 which comprises the radio frequency module, the demodulator, and decoders associated with the FEC) remain in the sleep mode excluding the listening of the corresponding bursts when no change in the tables and/or in the announcement channel is reported.

So, if the terminal 10 listens to service i corresponding to the frame 320, the time Δt separating the beginning of the current frame 320 from the next frame is indicated in the frame 320. So, as soon as the terminal detects the end of the frame, it places itself in standby mode up to the beginning of the next frame 320. So, the terminal 10 saves power, which is particularly advantageous if the terminal 10 is not continuously connected to a mains supply network (for example, battery terminal).

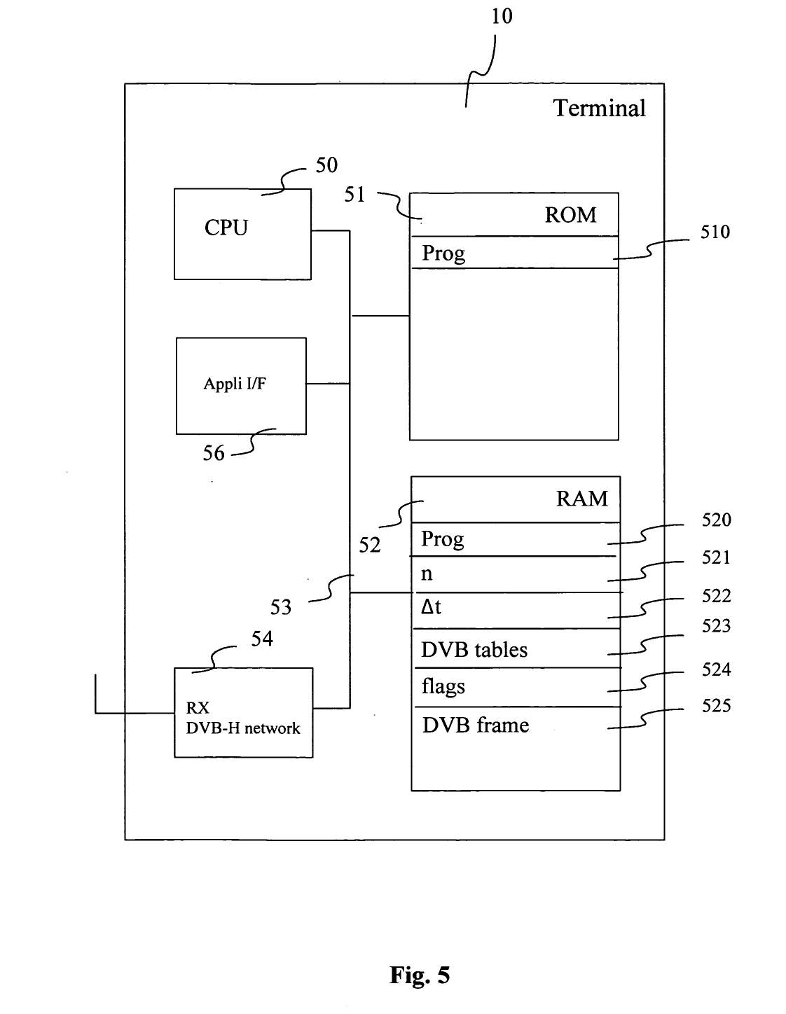

FIG. 4 illustrates, in more detail, the frame 320. The frame 320 comprises transport stream packets 3200 to 3209 of 188 bytes corresponding to service i and, possibly, one or more transport stream packet(s) 3210 corresponding to a system table transmitted almost continuously (for example, PAT tables (which correspond, as an example, to the transport stream packet 3210 the PID identifier of which is 0) and INT). Each transport stream packet has a small time δt compared with the time dt of the frame 320 which is, for example, equal to 150 ms (case of a frame corresponding to the filling of a MPE-FEC buffer memory of 256 bytes (192 data bytes and 64 FEC ('Forward Error Correction') bytes multiplied by the number of lines equal to 1024 namely about 2.1 Mbits, for a transmission bitrate of 15 Mbps (which uses for example a QAM modulation with 64 states)). In DVB-H, the video is transported under IP by using MPE (‘Multi Protocol Encapsulation’) frames used to transport IP packets in private data.

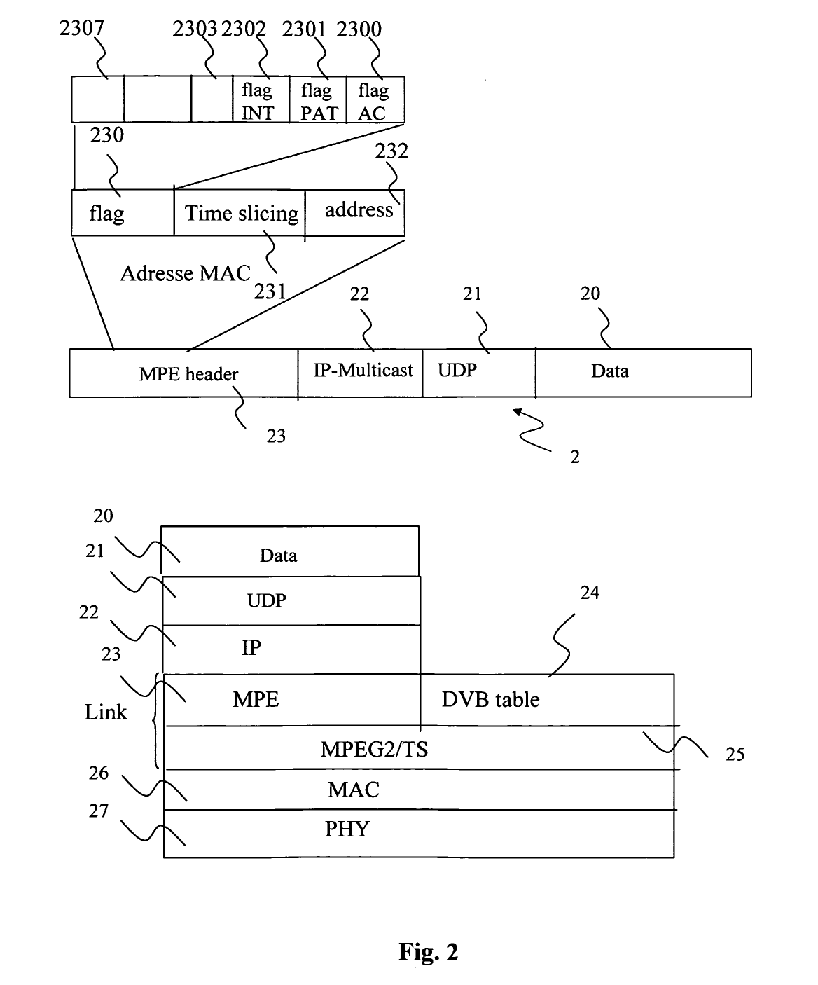

Each frame 320 comprises at least one MPE-FEC frame 2 such as illustrated in respect of FIG. 2. The frame 2 comprises:

a part 27 corresponding to the physical layer,

data 26 associated with the channel access layer (MAC),

a part corresponding to the link layer which is divided into a part 25 corresponding to a sub-layer of lower level MPEG2/TS and to a MPE sub-layer 23,

the MPE sub-layer 23 comprises an IP 22 layer,

the IP 22 layer comprises a UDP (or ‘User Datagram Protocol’) layer 21 (for example of the RTP (or ‘Real Time Protocol’) or FLUTE (or ‘File Delivery over unidirectional Transport’ type) defined by the RFC3926) standard, and

data 50.

The MPE header 23 comprises a field which was reserved for a MAC address in the first versions of the DVB standards. The MPE frames being broadcast, the MAC address is useless and, according to the invention, this field comprises:

a flag field 230 on one byte;

a time slicing field 231 on four bytes; and

a field 232 for a multicast address.

The flag field 230 itself comprises:

a field 2302 on one bit indicating a change or not in an INT table;

a field 2301 on one bit indicating a change or not in a FAT table;

a field 2300 on one bit indicating a change or not in an announcement channel, and

fields 2303 to 2307 not used and worth, for example, 0 by default.

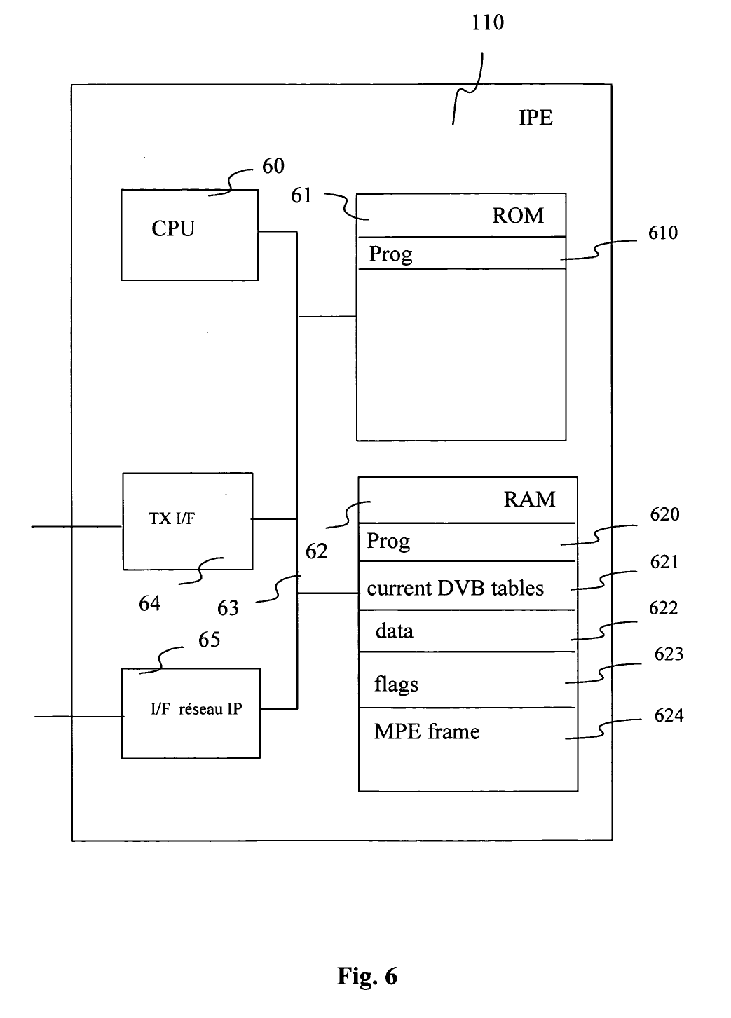

FIG. 5 diagrammatically illustrates the terminal 10. The terminal 10 comprises, interconnected by an address and data bus 53:

a microprocessor 50 (or CPU),

a non-volatile memory of the ROM (Read Only Memory) type 51

a random access memory or RAM 52,

a module 54 for receiving the signal received on the DVB-H (or 3G) network, and

an interface 56 transmitting the received images to the audio/video application (for example, for display or record).

Moreover, each of the elements illustrated in FIG. 5 is well known by the person skilled in the art. These common elements are not described here.

It is noted that the word “register” used in the description designates in each of the memories mentioned, a memory zone of low capacity (some binary data) as well as a memory zone of large capacity (enabling a whole programme to be stored or all or part of the data representing an audio/video service received).

The ROM 51 comprises in particular a “prog” program 510.

The algorithms implementing the steps of the method described hereafter are stored in the ROM 51 associated with the terminal 10 implementing these steps. When powered up, the microprocessor 50 loads and runs the instructions of these algorithms.

The random access memory 52 comprises in particular:

in a register 520, the operating program of the microprocessor 50 responsible for switching on terminal 10,

a required service reference n in a register 521,

a listening interval value Δt in a register 522,

current DVB tables 523 (in particular INT and FAT tables, and possibly data relating to the announcement channel),

flags 524 corresponding to received flags 2300 to 2302, and

one or more audio/video frames received in a register 523.

FIG. 6 diagrammatically illustrates the IPE module 110. The module 110 comprises, interconnected by an address and data bus 63:

a microprocessor 60 (or CPU),

a non-volatile memory of the ROM (Read Only Memory) type 61,

a random access memory or RAM 62;

an interface 64 to the transmitter or transmitters 64, and

an interface 65 receiving the service and/or signalling data to transmit of network 13.

Moreover, each of the elements illustrated in FIG. 6 is well known by the person skilled in the art. These common elements are not described here.

The ROM 61 comprises in particular a “prog” program 610.

The algorithms implementing the steps of the method described hereafter are stored in the ROM 61 associated with the module 110 implementing these steps. When powered up, the microprocessor 60 loads and runs the instructions of these algorithms.

The random access memory 62 comprises in particular:

in a register 620, the operating program of the microprocessor 60 responsible for switching on module 110,

data received or entered locally in a register 621,

the DVB system tables (for example FAT, INT and, according to a variant, the data relating to the announcement channel) in a register 622,

flags 663 corresponding to received flags 2300 to 2302, and

one or more MPE/FEC frames in a register 664.

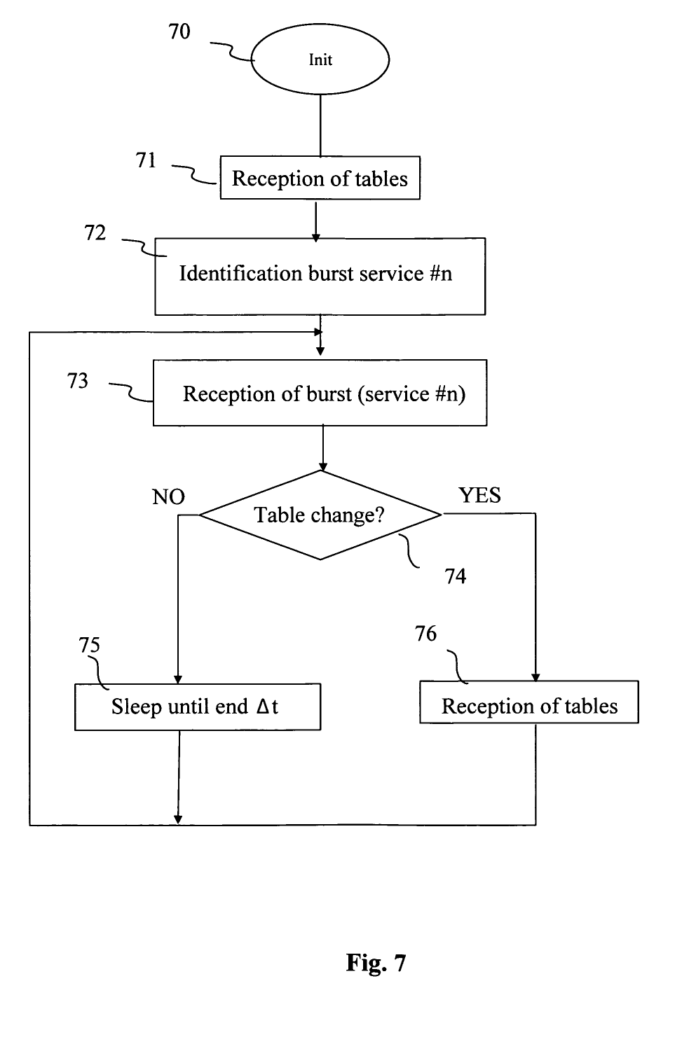

FIG. 7 illustrates a receiving algorithm implemented in the terminal 10.

During a first step 70, the terminal 10 initializes the various receipt parameters.

Then, during a step 71, the terminal 10 receives from the transmitter 112 the DVB tables and, in particular, the PAT, INT tables that it memorizes in the register 523.

Then, during a step 72, the terminal 10 presents to the user the services available according to the PAT and INT tables and identifies the burst associated with service n (bursts associated with services n) corresponding to the service(s) desired by the user, according to the content of the PAT and INT tables. The identifier n of the desired service is stored in the register 521. During one of the steps 71 or 72, the flag register 524 is initialized to 0.

Then, during step 73, the terminal 10 listens to the burst corresponding to service n. At the beginning of the burst, the terminal extracts the time Δt separating the beginning of the current frame from the beginning of the following burst associated with the same service n, starts a timer corresponding to the time Δt and memorizes this time in the register 522. The receipt of the burst continues up to the detection of an end of frame indicator present in the burst. The burst and/or the MPE frame or frames comprised in the burst are stored in a register 525.

Following step 73 or during step 73, during a step 74, the terminal 10 reads the flag field 230 contained in each MPE frame present in the received burst and checks if at least one of the flags 2300 to 2302 comprises a value equal to 1 corresponding to a change in the corresponding table.

If this is not the case (and after the end of step 73), during a step 75, the terminal 10 places in the sleep mode its means for receiving bursts until the timeout of time Δt expires. When this time expires (or slightly before to take account of the reaction times of the various elements of the terminal 10), step 73 is repeated.

In the affirmative, during a step 76, the terminal 10 still listens to the radio channel to receive the tables and/or the data transmitted on the announcement channel, a change having been indicated by one of the flags 2300 to 2302. So, if the flag 2302 indicates a change in the announcement channel, the terminal 10 still listens to the radio channel until a burst likely to contain the announcement channel is received and memorizes the content of the corresponding announcement channel so that it can be used by any application (for example, for presentation to the user of the terminal 10 or announcement of a new service). If several bursts contain information corresponding to the announcement channel, when the first burst is received, the terminal determines the next burst containing the announcement channel thanks to the dedicated pointer present in the first burst and processes the corresponding frames as if they were a service frame (it is no longer necessary to remain in standby mode after receiving the burst corresponding to service n). The terminal still listens to the bursts containing the announcement channel as long as the information on the channel is renewed. If the information on the channel is not renewed (for example, after expiry of a timeout) or if an end of transmission signal on the announcement channel is detected, the terminal 10 preferentially stops listening to the corresponding bursts.

Likewise, if the flag 2300 (respectively 2301) indicates a change in the PAT table (respectively INT), the terminal 10 still listens to the radio channel as long as the PAT table (respectively INT) is not received (this table can be in the burst 320 or not: if it is not in the burst 320, the terminal 10 listens to the next frame 321 (or the next frames 322 if necessary)). Upon reception of the PAT table (respectively INT), the terminal memorizes the table so that it can be used (for example, presentation to the user if a new service appears or handover to a service if a device is waiting in the case of a new PAT table) (for example, presentation and/or storage of a new IP address if a new INT table is received). So, the terminal 10 reacts very quickly as soon as a new system table and/or information on the announcement channel is or are transmitted while optimizing the power consumption of its radio reception means.

When the information of the announcement channel and/or of the PAT and INT tables has been received, the terminal repeats the burst receiving step 73. Preferentially, the burst receiving means of the terminal 10 are put into sleep mode until the Δt timeout expires before repeating the step 73.

Preferentially, the flags 2300 to 2302 are activated in several consecutive MPE frames corresponding to the same service n to make it possible for the terminal 10 to detect a change if a corresponding burst is not correctly received. In this case, several embodiments are possible, and in particular:

according to a first embodiment relatively simple to implement and such as described above, the terminal 10 systematically reacts to the detection of a change by carrying out the corresponding processing operations during the step 76,

according to a second mode making it possible to optimize the power consumption (for receiving and processing), the terminal 10 carries out the step 76 only once (for example, by not carrying out the step 76 as long as the associated flag(s) has/have not returned to state 0 indicating no change, or as long as a timeout of a few seconds started during a return to one of a flag 2300 to 2302 has not expired).

According to an embodiment variant, the value changes of the flags 2300 to 2302 indicate a state change respectively of a PAT table, of an INT table or in the announcement channel. According to this embodiment, the terminal 10 memorizes the current flags and compares them to the flags received during the step 74. This variant has the advantage of enabling the terminal 10 to precisely determine if it has taken a change into account.

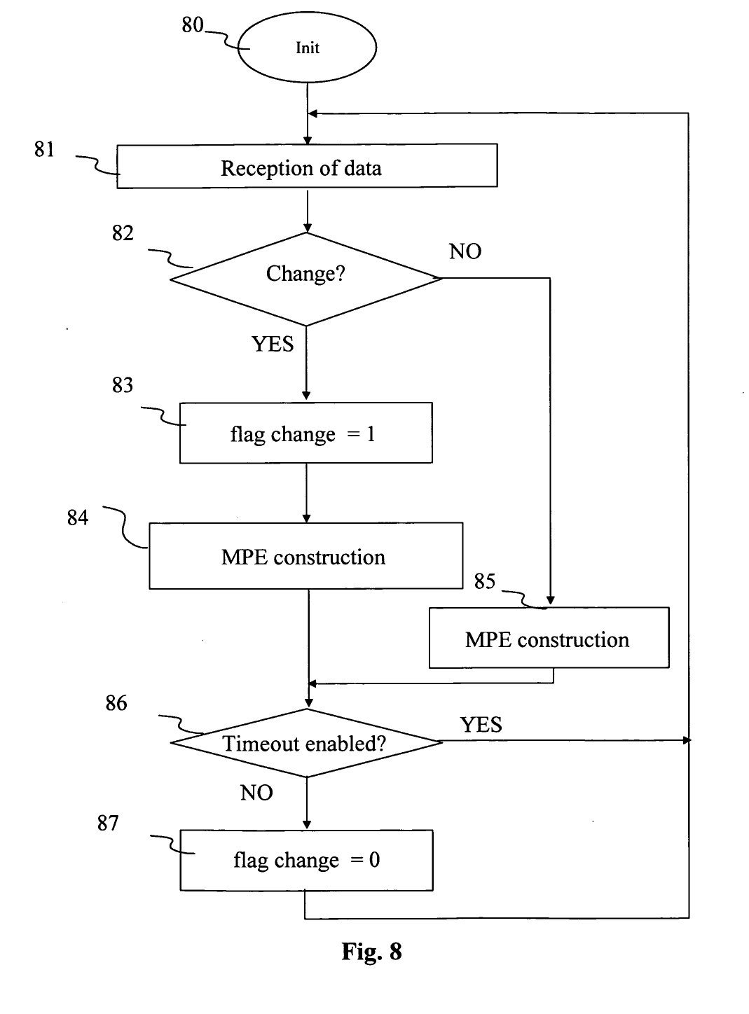

FIG. 8 illustrates a receiving algorithm implemented in the module 110 generating and/or detecting a change in system tables (for example, INT and PAT) and/or the announcement channel and updating the corresponding flag or flags.

During a first step 80, the IPE module 110 initializes the various parameters for the receipt of frames of the IP 13 network and transmission of MPE frames to the transmitter 112. The register 622 is initialized to a value indicating that no system table has been generated. The flags corresponding to changes are initialized to a null value, indicating, by default, no change.

Then, during a step 81, the IPE module 110 receives data corresponding to service streams and/or a module configuration and memorizes them in a register 622. The configuration data is, for example, entered by the operator directly in the module or received via the IP network or any other link.

Then, during a test 82, the IPE module 110 checks whether a change occurs in the system tables (PAT and/or INT) or in the announcement channel. A change in a system table can occur in particular when configuration data is modified by an operator and/or upon receipt of a new stream (authorized by prior configuration). More generally, the IPE module 110 detects changes in the services (change in a service being transmitted or new service for example) transmitted to transmitter 112. A change can also occur when the IPE 110 is configured to react on a parameter specific to a stream, for example, according to a bitrate the value of which less than or greater than a predefined threshold leads to a change in the radio transmission to the terminal.

If information that must be transmitted on the announcement channel (for example, meta data relating to a new service) is received from the source 153, the module 110 considers that there is a change in the announcement channel: according to a particular embodiment, all the information concerning the announcement channel must be transmitted once or a small number of times, by default, the announcement channel not being used; according to a variant, the same announcement channel information is repeated many times: in this case, the IPE module 110 memorizes in the memory 62, the last transmitted information associated with the announcement channel and compares it with current information also memorized in the memory 62.

In the negative, during a step 85, the module 110 constructs a MPE frame with in particular a header comprising the updated flags 2300 to 2302 and data 622 corresponding to a service, system tables and/or an announcement channel.

In the affirmative, a change occurs and, during a step 83, the flags 2300 to 2302 corresponding to the change are updated with a value equal to 1. The module 110 also starts a timeout of a time T which corresponds to the time during which the flags indicating a change are activated. The time T is greater than or equal to the ΔT time to make it possible for each terminal receiving a service n to receive the flag indicating a change. Preferentially, the time T is greater than or equal to several times the ΔT time to make it possible for each terminal receiving a service n to receive the flag indicating a change even if bursts are lost. So, T is advantageously greater than or equal to twice the ΔT time and less than or equal to 10 times the ΔT time (2ΔT<=T<=10ΔT) (ΔT being in the order of 1 to 3 seconds).

Following step 83, during a step 84, the module 110 constructs a MPE frame with in particular a header comprising the updated flags 2300 to 2302 and data 622 corresponding to a service, system tables and/or an announcement channel.

Following one of the steps 84 or 85, during a test 86, the module 110 checks if the timer associated with the flag updated during the step 83 is active.

If this is the case, the last timeout started during the step 83 having expired, during a step 87, the flags 2300 to 2302 are reinitialized to a null value.

Following the step 87, or if the last timeout started during the step 83 has not expired, the step 81 is repeated.

According to the described embodiment, only one timer is used when one of the flags 2300 to 2302 is activated. According to an embodiment variant, each flag 2300 to 2302 is associated with a timeout. So, the timeout value can be defined according to the associated flag and only the associated flag value is reinitialized after expiry of the associated timeout during the step 87, the test 86 independently testing each of the timers.

As indicated in respect of FIG. 7, according to an embodiment variant, the value changes of the flags 2300 to 2302 indicate a state change respectively of a PAT table, of an INT table or in the announcement channel. This embodiment is implemented in a dual manner on the terminal 10 side and on the module 110 side which changes the state of the flag or flags concerned during the steps 83 and 87.

According to a variant, the transmitter 112 is connected to the IPE module and to another system transmitting DVB-T tables via a multiplexer. In this case, advantageously, configuration change information is transmitted to the IPE module by the other system to make it possible for the IPE module to update one or more flags dedicated to the DVB-T tables, this flag or flags being moreover managed like the flags 2300 to 2302.

Naturally, the invention is not limited to the embodiments previously described.

In particular, the insertion of the flags indicating the changes can be done not only in the IPE but also in a dedicated module located in the IPE or downstream of the IPE (between the IPE and the radio transmitter).

If several IPE are connected to the same radio transmitter, according to a variant of the invention, the IPE exchange information concerning system table changes and/or a particular channel that all the terminals are supposed to listen to. In this case, each IPE updates the corresponding flags that it inserts in the MPE frames that it generates.

Moreover, the invention is also compatible with several radio transmitters connected to one or more IPE, each of the transmitters transmitting to one or more terminals bursts containing the received MPE.

The invention is also not limited to the flags described above but also concerns the update, the transmission, the receipt and the processing operations following the reception of flags relating to any system tables, to information transmitted in a noticeably continuous way or in dedicated bursts, this information being intended for one or more terminals receiving a DVB service.

According to the invention, the flags have any format. Advantageously, the flag or flags is or are included in an unused field of the MPE frames. According to other variants of the invention, the flag or flags is/are inserted in bursts at any predefined location in particular in a header of one of the packets encapsulated by a MPE frame (for example, RTP packet). In addition, each flag can be assigned to a precise table or a particular channel, which makes it possible for the terminal to better target the data to be recovered. According to a variant, a part or all the flags are grouped on only one binary element (or bit).

1. Method for broadcasting digital video services comprising a step for transmitting digital video broadcasting services in bursts to at least one terminal having a standby mode and a sleep mode, wherein at least one part of the bursts associated with a channel comprises information representative of a change in the content of the bursts not associated with said channel, so that the terminal can be in standby mode to receive data relating to the content of the bursts not associated with said channel, having changed.

2. Method according to claim 1, wherein it comprises a step for inserting multi-protocol encapsulation frames called MPE frames in the said bursts, at least one part of the said MPE frames comprising said information representative of a change in the content of the bursts.

3. Method according to claim 2, wherein each of the MPE frames comprises said information representative of a change in the content of the bursts.

4. Method according to claim 1, wherein it comprises a step for inserting said information in at least a part of said MPE frames by a module generating said MPE frames.

5. Method according to claim 1, wherein said information is representative of a system table change.

6. Method according to claim 1, wherein said information is representative of an announcement channel change.

7. Method according to claim 1, wherein it comprises a step for changing the state of said information during a change in the content of the bursts.

8. Method for receiving bursts, each of said bursts comprising at least a digital video broadcasting service, wherein it comprises the steps for:
receiving at least a burst associated with a channel, by a terminal in standby mode,
detecting in a burst received and associated with said channel, information representative of a change in the content of at least a burst broadcast and not associated with said channel.

9. Method according to claim 8, wherein it comprises a step for maintaining in standby mode when the terminal has detected said information representative of a change as long as the terminal has not received the data corresponding to the content of the broadcast bursts, having changed.

10. Method according to claim 8, wherein said information is representative of a system table change.

11. Method according to claim 8, wherein said information is representative of an announcement channel change.

12. Method according to claim 8, wherein it comprises a step for detecting a state change of said information, a state change being representative of a change in the content of the bursts.

13. Device for broadcasting digital video services comprising a transmitter transmitting digital video broadcasting services in bursts to at least one terminal having a standby mode and a sleep mode, wherein at least one part of the bursts associated with a channel comprises information representative of a change in the content of the bursts not associated with said channel, so that the terminal can be in standby mode to receive data relating to the content of the bursts having changed and not associated with said channel.

14. Device for receiving bursts, each of said bursts comprising at least one digital video broadcasting service, wherein it comprises:
a receiver adapted to receive at least a burst associated with a channel by a terminal in standby mode,
a detector adapted to detect in a received burst, information representative of a change in the content of at least a burst broadcast and not associated with said channel.
